(19) United States
(12) Patent Application Publication
(10) Pub. No.: US 2022/0375690 A1
(43) Pub. Date: Nov. 24, 2022

(54) FILM CAPACITOR DEVICE

(71) Applicant: KYOCERA Corporation, Kyoto-shi, Kyoto (JP)

(72) Inventor: Naoki KIKUCHI, Kirishima-shi (JP)

(73) Assignee: KYOCERA Corporation, Kyoto-shi, Kyoto (JP)

(21) Appl. No.: 17/769,983

(22) PCT Filed: Oct. 19, 2020
(86) PCT No.: PCT/JP2020/039276

§ 371 Date: Apr. 18, 2022

(30) Foreign Application Priority Data
Oct. 30, 2019 (JP) 2019-197887

(51) Int. Cl. H01G 4/33; H01G 4/18; H01G 4/224; H01G 4/012; H01G 4/232

(52) U.S. Cl. CPC H01G 4/33; H01G 4/18; H01G 4/224; H01G 4/012; H01G 4/232

(57) ABSTRACT

A film capacitor device includes a capacitor body, a metal electrode on each of side surfaces of the capacitor body, an external electrode electrically connected to the metal electrode, and a bond bonding the metal electrode and the external electrode together. The capacitor body includes a plurality of unit stacks being stacked. The plurality of unit stacks each include a film stack including a plurality of dielectric films being stacked and a pair of protective films covering surfaces of the film stack. The plurality of unit stacks in the capacitor body are stacked with end faces of the plurality of unit stacks in a first direction (x-direction) being displaced.

### FIELD

The present disclosure relates to a film capacitor device.

### BACKGROUND

A known technique is described in, for example, Patent Literature 1.

### CITATION LIST

### Patent Literature

Patent Literature 1: WO 2014/178133

### BRIEF SUMMARY

A film capacitor device according to an aspect of the present disclosure includes a capacitor body, a metal electrode, an external electrode, and a bond. The capacitor body includes a plurality of unit stacks each including a film stack and a pair of protective films. The film stack is rectangular and includes a plurality of dielectric films being stacked. Each of the plurality of dielectric films includes metal strips extending in a first direction on the dielectric film. The plurality of dielectric films include adjacent dielectric films in 180° opposite orientations in the first direction. The pair of protective films cover a pair of surfaces of the film stack in a stacking direction. The plurality of unit stacks are stacked with end faces of the plurality of unit stacks in the first direction being displaced. The metal electrode is on each of a pair of end faces of the capacitor body in the first direction. The external electrode is electrically connected to the metal electrode. The bond bonds the metal electrode and the external electrode together.

The objects, features, and advantages of the present disclosure will become more apparent from the following detailed description and the drawings.

### BRIEF DESCRIPTION OF DRAWINGS

FIG. 1 is a schematic cross-sectional view of a film capacitor device.

FIG. 2 is a plan view of a dielectric film.

FIG. 3 is an enlarged cross-sectional view of the film capacitor device.

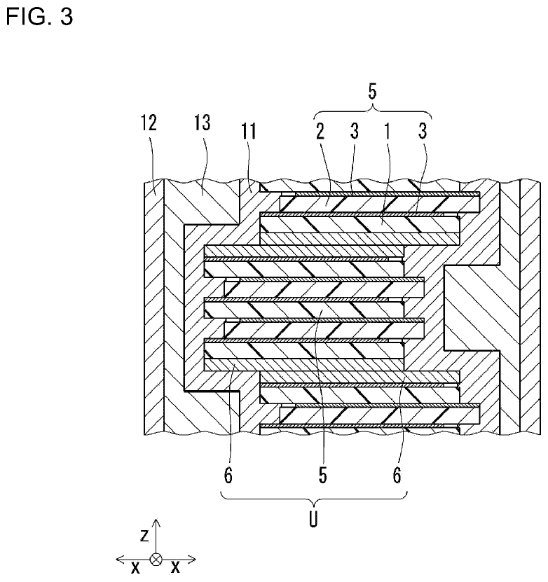

FIG. 4 is a perspective view of the film capacitor device.

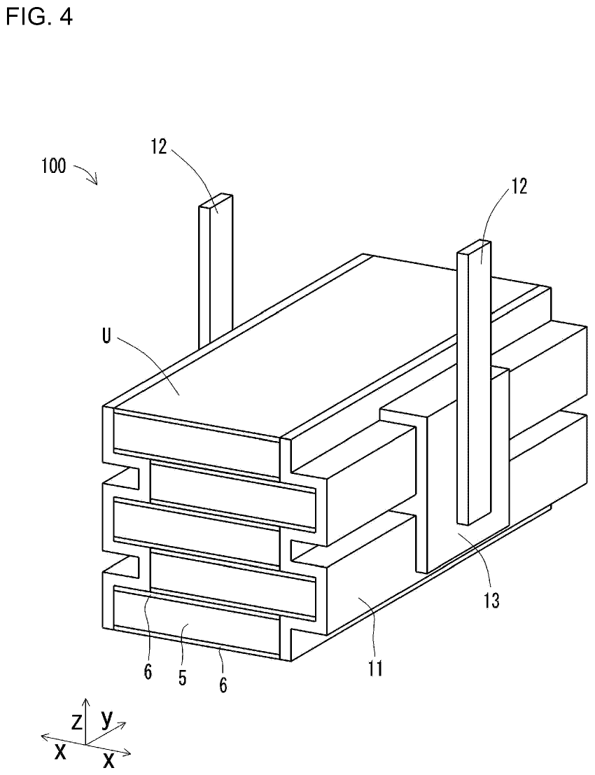

FIG. 5 is a schematic cross-sectional view of a film capacitor device according to another embodiment.

FIG. 6 is a schematic cross-sectional view of a film capacitor device according to another embodiment.

FIG. 7 is a schematic cross-sectional view of a film capacitor device according to another embodiment.

### DETAILED DESCRIPTION

A film capacitor device according to one or more embodiments will now be described with reference to the drawings.

A film capacitor with the structure that forms the basis of a film capacitor device according to one or more embodiments of the present disclosure includes either a wound metalized film or metalized films stacked in one direction, which are metal films to be electrodes formed by vapor deposition, on the surface of a dielectric film of, for example, a polypropylene resin.

Electronic devices incorporating such film capacitors have been smaller and more functional. The film capacitors are thus to be smaller and to have higher capacity. To increase capacity, an electronic device may incorporate more capacitors. With such capacitors using a larger mount area, the electronic device cannot be downsized. Each capacitor may include more stacked layers to increase capacity. However, this structure may lower the yield or workability of the capacitors.

A capacitor device described in Patent Document 1 includes capacitor elements stacked on one another. The capacitor elements each include a basic unit including dielectric films and internal electrode films alternately stacked on one another, and protective films stacked on the basic unit.

A stacked film capacitor includes metal electrodes (metal-sprayed electrodes) electrically connected to internal electrodes. The metal electrodes are bonded to external electrodes with a bonding material. The bonding strength between the metal electrodes and the external electrodes is to be increased.

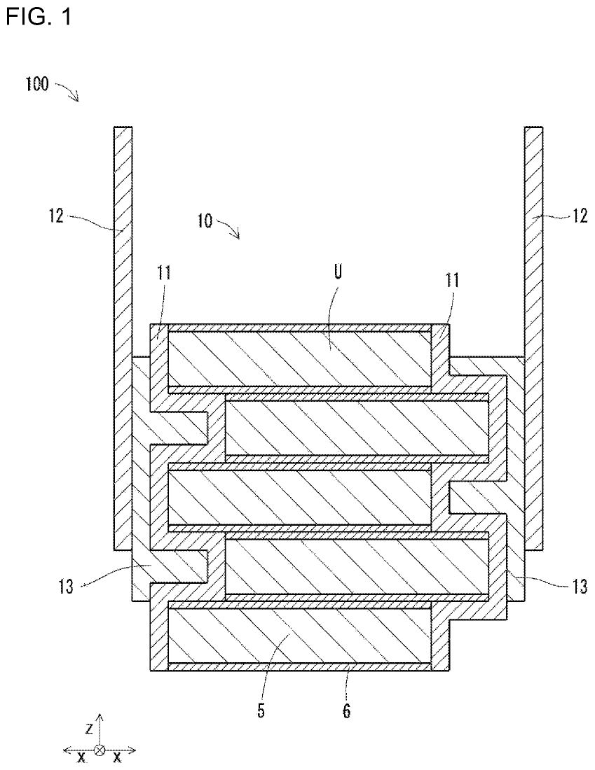

A film capacitor device 100 according to an embodiment shown in FIG. 1 includes a capacitor body 10, metal electrodes 11 on the side surfaces of the capacitor body 10, external electrodes 12 electrically connected to the metal electrodes 11, and bonds 13 that bond the metal electrodes 11 and the external electrodes 12 together. The capacitor body 10 includes multiple unit stacks U stacked on one another. Each unit stack U includes a film stack 5 including multiple dielectric films 1 and 2 stacked on one another, and a pair of protective films 6 covering the surfaces of the film stack 5.

The film stack 5 includes multiple dielectric films 1 and 2 stacked on one another. Each of the dielectric films 1 and 2 includes metal strips 3 extending in a first direction (x-direction in the figure).

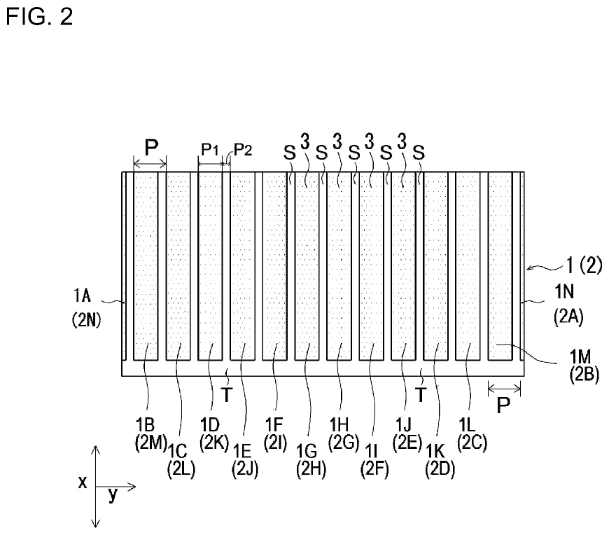

After being stacked, the metal strips 3 serve as internal electrodes of the capacitor. The dielectric films 1 and 2 have the same structure with the difference being their stacking orientations by 180°. To indicate the orientations in the stacked structure, the metal strips 3 are denoted with numerals 1A to 1N or numerals 2A to 2N in this order from an end of the dielectric film as shown in FIG. 2.

The direction in which the metal strips 3 extend parallel to one another is referred to as the first direction (x-direction), and the direction in which the metal strips 3 align parallel to one another (y-direction perpendicular to x-direction) is referred to as a second direction. The films are stacked on one another in a third direction (z-direction in the figure) perpendicular to the first and second directions.

The metal strips 3 on the surface of each of the dielectric films 1 and 2 are formed by depositing metal on a base film (substrate) by vapor deposition. Each of the dielectric films 1 and 2 has surface portions, which are also referred to as small margins, each exposed between the metal strips 3 adjacent to each other in y-direction (hereafter, insulation margins S). The metal strips 3 are thus electrically separate and insulated from one another.

Each of the insulation margins S (small margins) is continuous with an insulating strip area T at an end of the dielectric film in the first direction (x-direction). The insulating strip area T, which is also referred to as a large margin, continuously extends in the second direction (y-direction). The interval (pitch P) between the insulation margins S is equal to the sum of a width P1 of one metal strip 3 in y-direction and a width P2 of one insulation margin S in y-direction (P=P1+P2).

The dielectric films 1 and 2 included in the film capacitor device may be formed from an organic resin material such as polypropylene, polyethylene terephthalate, polyarylate, or cyclic olefin polymer.

The film stack 5 includes the dielectric films 1 and 2 that are adjacent to each other in the vertical direction (z-direction) in the figure and are stacked alternately in the opposite orientations in x-direction. More specifically, the dielectric films 1 and 2 are stacked on one another to have their insulating strip areas T each located at an end (edge) of the corresponding dielectric film 1 or 2 to be alternately opposite to each other in x-direction. The pair of protective films 6 cover a pair of surfaces of the film stack 5 in the stacking direction (third direction).

The protective films 6 protect the dielectric films 1 and 2. The protective films 6 may thus be any electrically insulating films that can prevent entry of, for example, moisture from outside. The protective films 6 may be formed from the same organic resin material as the dielectric films 1 and 2 or from a different material.

Each unit stack U is an integral unit including a film stack 5 and a pair of protective films 6. The capacitor body 10 includes multiple unit stacks U that are stacked on one another in the third direction (z-direction). In the capacitor body 10, the unit stacks U are stacked with their end faces in the first direction (x-direction) being displaced from one another. The unit stacks U may be displaced in x-direction in any manner. The unit stacks U may be displaced one by one or every set of multiple unit stacks U may be displaced from one another. The unit stacks U may be displaced in x-direction in the same orientation or in the opposite orientations from one another. In the present embodiment, the unit stacks U are stacked on one another with displacement in the opposite orientations. For a capacitor body 10 including three or more unit stacks U stacked on one another, one end face of the capacitor body 10 in x-direction has a groove extending in y-direction, and the other end face in x-direction has a ridge extending in y-direction.

The capacitor body 10 including multiple stacked unit stacks U includes, on its two end faces in x-direction, metal electrodes that are formed by metal thermal spraying (hereafter, metal-sprayed electrodes 11). The metal-sprayed electrodes 11 are bonded to the external electrodes 12 with the bonds 13 to be electrically connected to the external electrodes 12. The metal-sprayed electrodes 11 may be formed from a material such as zinc, tin, aluminum, brass, or silver.

Each external electrode 12, also referred to as a busbar, serves as a current path for applying a current or a voltage to the film capacitor device 100 from outside. The external electrodes 12 are bonded to the corresponding metal-sprayed electrodes 11 with the bonds 13. The external electrodes 12 may be formed from a material such as copper, brass, or aluminum. The bonds 13 may be formed from a material such as silver, tin, lead, copper, zinc, or aluminum, in addition to solder.

For a capacitor body 10 including multiple unit stacks U stacked on one another without displacement, as in the structure that forms the basis of the embodiments of the present disclosure, the capacitor body 10 has flat end faces in x-direction. The metal-sprayed electrodes 11 on the end faces of the capacitor body 10 may thus have flat surfaces. The external electrodes 12 are bonded to the flat surfaces with the bonds 13. In the present embodiment, the capacitor body 10 has, on its end faces in x-direction, staggered surfaces including grooves and ridges resulting from the displacement of the stacked unit stacks U. The metal-sprayed electrodes 11 also have staggered surfaces including grooves and ridges in conformance with the staggered surfaces on the end faces of the capacitor body 10.

The staggered surfaces of the metal-sprayed electrodes 11 increase the bonding area between the metal-sprayed electrodes 11 and the bonds 13, increasing the bonding strength between them. The staggered surfaces of the metal-sprayed electrodes 11 result from steps parallel in y-direction. As shown in, for example, FIG. 1, the external electrodes 12 are more apart from the unit stacks U in the areas adjacent to the steps than the corresponding areas in the structure that forms the basis of the embodiments of the present disclosure. The structure in the figure thus reduces the likelihood that heat applied to the bonds 13 for bonding the capacitor body 10 and the external electrodes 12 is transmitted to the unit stacks U. Upon being heated, the unit stacks U may be deformed or the bonding strength between the unit stacks U and the metal-sprayed electrodes 11 may decrease. The steps on the surfaces of the metal-sprayed electrodes 11 reduce such heat transfer and thus a decrease in the bonding strength. The bonds 13 may be fluidized by heating during bonding. The steps also prevent the fluidized bonds 13 from flowing down in the stacking direction (z-direction), reducing a decrease in the bonding strength.

The bonds 13 may have flat surfaces or have surfaces in conformance with the surfaces of the metal-sprayed electrodes 11. For the external electrodes 12 being rod-, strip-, or plate-shaped, the contact surfaces may be flat between the external electrodes 12 and the bonds 13. For the bonds 13 with flat surfaces, the contact area between the bonds 13 and the external electrodes 12 increases, thus increasing the bonding strength and decreasing the contact resistance. The contact surfaces between the external electrodes 12 and the bonds 13 may be staggered. In this case, the contact area between the bonds 13 and the external electrodes 12 increases further, increasing the bonding strength and decreasing the contact resistance.

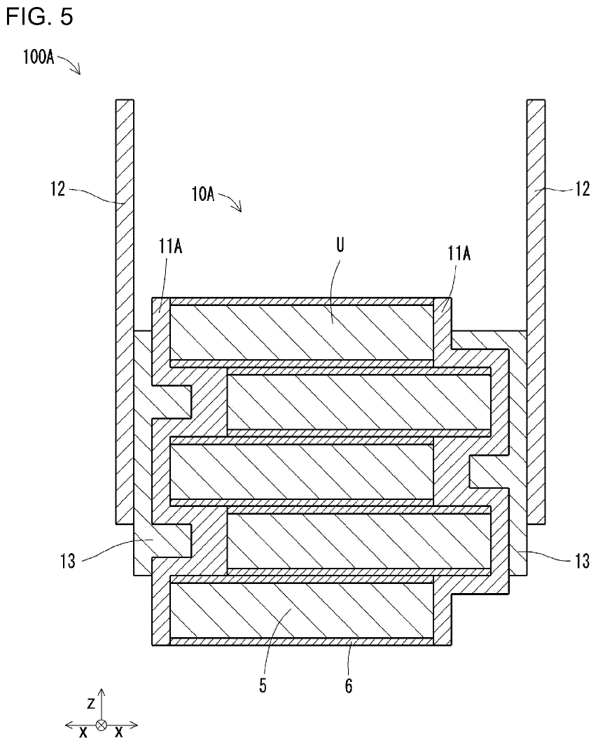

FIG. 5 is a schematic cross-sectional view of a film capacitor device according to another embodiment. A film capacitor device 100A according to the present embodiment is the same as the film capacitor device 100 in, for example, FIG. 1, except the structure of metal-sprayed electrodes 11A. The same components other than the metal-sprayed electrodes 11A are given the same reference numerals and will not be described. A capacitor body 10A in the present embodiment includes the metal-sprayed electrodes 11A having staggered surfaces including grooves and ridges. The metal-sprayed electrodes 11A have portions corresponding to the grooves thicker than other portions. In the portions corresponding to the grooves, the bonds 13 are apart from the unit stacks U. This structure further reduces the likelihood that heat applied for bonding the external electrodes 12 is transmitted to the unit stacks U, reducing a decrease in the bonding strength.

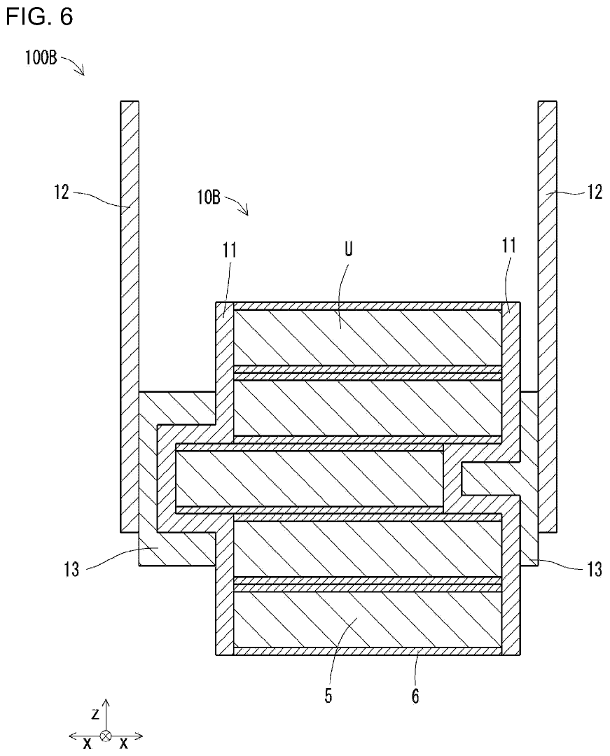

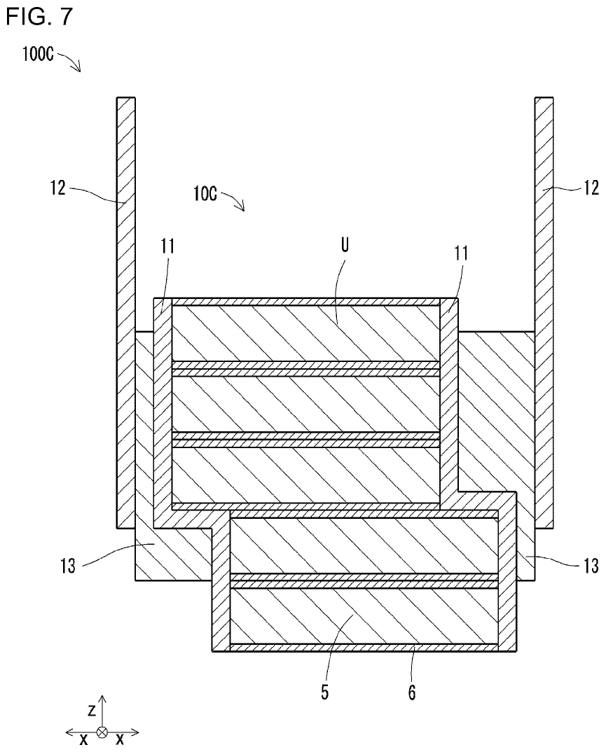

In the above embodiment, the capacitor body 10 includes unit stacks U stacked on one another with displacement in the opposite orientations. However, the structure is not limited to the above embodiments. For example, as shown in the schematic cross-sectional view in FIG. 6, a film capacitor device 100B according to another embodiment includes a capacitor body 10B including multiple unit stacks U stacked on one another with one of the multiple unit stacks U alone being displaced in the opposite orientation. For example, as shown in the schematic cross-sectional view in FIG. 7, a film capacitor device 100C according to another embodiment includes a capacitor body 10C including multiple unit stacks U stacked on one another with sets of multiple unit stacks U being displaced in the opposite orientations. Each set of multiple unit stacks U may include the same number of unit stacks U or different numbers of unit stacks U.

The present disclosure may be implemented in the following forms.

A film capacitor device according to one or more embodiments of the present disclosure includes a capacitor body, a metal electrode, an external electrode, and a bond. The capacitor body includes a plurality of unit stacks each including a film stack and a pair of protective films. The film stack is rectangular and includes a plurality of dielectric films being stacked. Each of the plurality of dielectric films includes metal strips extending in a first direction on the dielectric film. The plurality of dielectric films include adjacent dielectric films in 180° opposite orientations in the first direction. The pair of protective films cover a pair of surfaces of the film stack in a stacking direction. The plurality of unit stacks are stacked with end faces of the plurality of unit stacks in the first direction being displaced. The metal electrode is on each of a pair of end faces of the capacitor body in the first direction. The external electrode is electrically connected to the metal electrode. The bond bonds the metal electrode and the external electrode together.

The film capacitor device according to one or more embodiments of the present disclosure has reliably increased bonding strength between the metal electrodes and the external electrodes.

Although the embodiments of the present disclosure have been described in detail, the present disclosure is not limited to the above embodiments, and may be modified or changed variously without departing from the spirit and scope of the present disclosure. The components described in the above embodiments may be entirely or partially combined as appropriate unless any contradiction arises.

### REFERENCE SIGNS LIST

1, 2 dielectric film
3 metal strip
5 film stack
6 protective film
10 capacitor body
11 metal electrode (metal-sprayed electrode)
12 external electrode
13 bond
100 film capacitor device
U unit stack

1. A film capacitor device, comprising:
a capacitor body including a plurality of unit stacks, each of the plurality of unit stacks including
a film stack being rectangular and including a plurality of dielectric films being stacked, each of the plurality of dielectric films including metal strips extending in a first direction on the dielectric film, the plurality of dielectric films including adjacent dielectric films in 180° opposite orientations in the first direction, and
a pair of protective films covering a pair of surfaces of the film stack in a stacking direction,
the plurality of unit stacks being stacked with end faces of the plurality of unit stacks in the first direction being displaced;
a metal electrode on each of a pair of end faces of the capacitor body in the first direction;
an external electrode electrically connected to the metal electrode; and
a bond bonding the metal electrode and the external electrode together.

2. The film capacitor device according to claim 1, wherein
the capacitor body includes the plurality of unit stacks displaced in opposite orientations.

3. The film capacitor device according to claim 1, wherein
the bond has a dimension in the stacking direction greater than or equal to a thickness of each of the plurality of unit stacks.

4. The film capacitor device according to claim 1, wherein
the metal electrode has a staggered surface including grooves and ridges in conformance with a staggered surface on each of the pair of end faces of the capacitor body.

5. The film capacitor device according to claim 1, wherein
the metal electrode has a staggered surface including grooves and ridges, and the metal electrode has portions corresponding to the grooves thicker than other portions.
